(19) United States
(12) Patent Application Publication
(10) Pub. No.: US 2004/0084930 A1
(43) Pub. Date: May 6, 2004

(54) Trim hardware carrier

(76) Inventors: Jin Cheng Lin, Farmington HIlls, MI (US); Dennis John Buening, Northville, MI (US); Radoslav Bokun, Windsor (CA); Manfred Fritsch, Highland, MI (US); David Krysiak, Pleasant Ridge, MI (US); Daniel L Wenglinski, Taylor, MI (US)

Correspondence Address: Robin W Asher, Clark Hill, Suite 3500, 500 Woodard Avenue, Detriot, MI, 48226-3435, US

(21) Appl. No.: 10/250,837

(22) PCT Filed: Jan. 7, 2003
(86) PCT No.: PCT/CA03/00040

(30) Foreign Application Priority Data
Jan. 7, 2002 (US) 60346359

(51) Int. Cl. B60J 5/00

(52) U.S. Cl. 296/146.7

(57) ABSTRACT

A method for assembling a motor vehicle door includes the steps of affixing a plurality of hardware components to a secondary trim component to form a door module assembly. The door module assembly is attached to the structural door body. A trim panel is secured to the structural door body overlaying the door module assembly. The secondary trim component has a map pocket wall and the trim panel has a map pocket opening. When the trim panel overlays the secondary trim component, the trim panel cooperates with the secondary trim component to define a map pocket.

### FIELD OF THE INVENTION

This invention relates to a door module assembly for a motor vehicle door. More particularly, the invention relates to a method for assembling a motor vehicle door that utilizes a trim panel component as a structural carrier for a door module assembly.

### DESCRIPTION OF RELATED ART

A motor vehicle door typically includes a structural door body having an outer sheet metal panel and an inner sheet metal panel, a plurality of hardware components mounted within an inner cavity formed between the outer and inner sheet metal panels, and an interior trim panel. The complete assembly of the door involves multiple manufacturing steps and numerous parts. Conventionally, an original equipment manufacturer (OEM) will install each individual hardware component and the trim panel to the structural door body along an assembly line.

The conventional installation of the hardware components has, however, several drawbacks. First, a high assembly cycle time is required to assemble the door in this fashion since installation of each hardware component is a separate task requiring human effort. Second, operability of the hardware components cannot be determined until the respective components are installed onto the door. Thus, time and labor may be wasted installing inoperable components. Finally, additional time is required to inventory each hardware component as it arrives at the OEM to ensure that all of the hardware components are available for assembly.

Pre-assembled door modules have been proposed to overcome the deficiencies of conventional door assembly methods. A door module typically involves utilizing a structural carrier member to partially assemble and orient hardware components thereto prior to installation to the structural door body. One disadvantage associated with such door modules is that once the door module is installed to the door, the structural carrier member serves little or no purpose since all of the hardware components are eventually securely fastened to the structural door body.

U.S. Pat. No. 6,148,564 discloses one example of a vehicle door module. A motor vehicle door includes an inner panel having an aperture. A door module is mounted on the inner panel. The door module includes an X-shaped structural member having a central portion and arms extending therefrom. A free end of each arm is secured to the inner panel. The door module also includes a support panel, which is secured to the structural member and to the inner panel. Various door components, including a window lift mechanism, an electric motor, and a door latch handle, are mounted on the support panel and the structural member. The door module can be preassembled before mounting on the inner panel. The structural member of the module serves, however, no purpose once the module is mounted along the inner panel.

Thus, there remains a need for a door module that is assembled entirely from existing door components.

### SUMMARY OF THE INVENTION

The disadvantages of the related art may be overcome by providing a method for manufacturing a motor vehicle door utilizing a door module assembly including a trim panel component and a plurality of hardware components secured thereto prior to assembly to a structural door body of the door.

According to one aspect of the invention there is provided a method for assembling a motor vehicle door. The method includes the steps of affixing a plurality of hardware components to a secondary trim component to form a door module assembly. The door module assembly is attached to the structural door body. A trim panel is secured to the structural door body overlaying the door module assembly. The secondary trim component has a map pocket wall and the trim panel has a map pocket opening. When the trim panel overlays the secondary trim component, the trim panel cooperates with the secondary trim component to define a map pocket.

According to another aspect of the invention, there is provided a door module assembly. The door module assembly comprises a trim panel having a map pocket opening and a secondary trim component having a map pocket wall. A plurality of door hardware components are affixed to the secondary trim component. The trim panel cooperates with the secondary trim component to define a map pocket when the trim panel overlays the secondary trim component.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is an exploded, perspective view of a motor vehicle door including a door module assembly according to the inventive method;

FIG. 2 is a front view of the door module assembly according to the inventive method;

FIG. 3 is a rear view of the door module assembly according to the inventive method;

FIG. 4 is a front view of an inner sheet metal layer of the motor vehicle door including access holes for receiving the door module assembly according to the inventive method;

FIG. 5 is a front view of the inner sheet metal layer having the door module assembly secured thereto according to the inventive method; and

FIG. 6 is a rear view of a trim panel for affixing to the motor vehicle door according to the inventive method.

### DETAILED DESCRIPTION OF THE PREFERRED EMBODIMENT

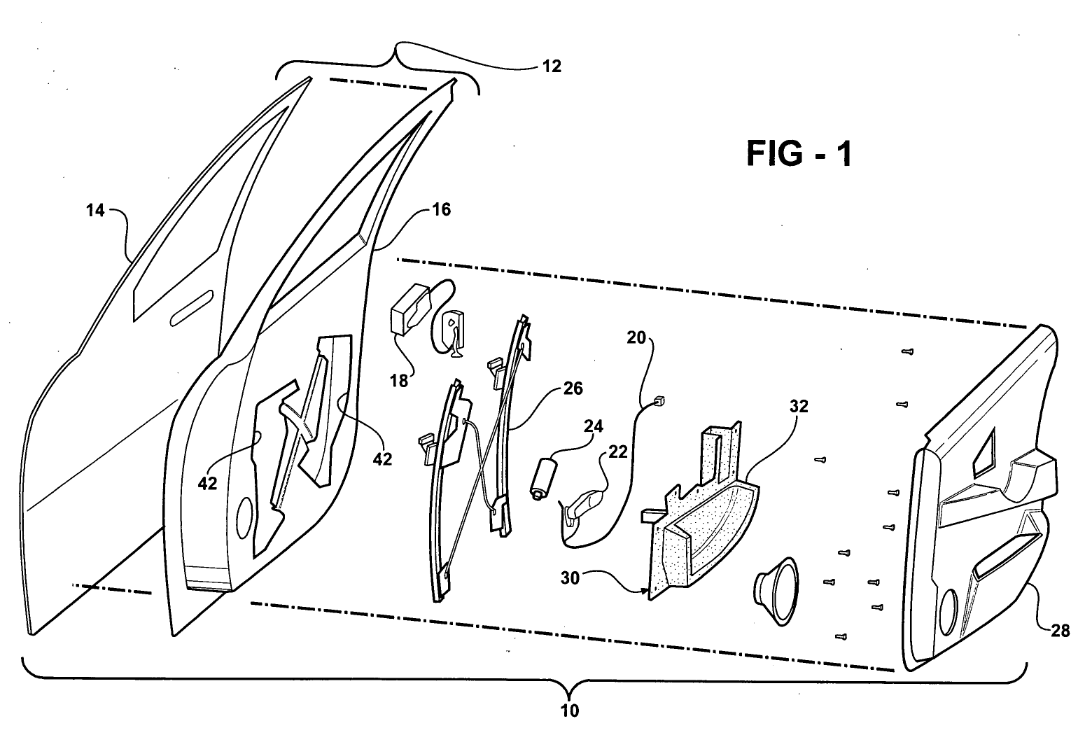

Referring to FIG. 1, a motor vehicle door, generally shown at 10, includes a structural door body 12 having outer 14 and inner 16 sheet metal layers. A plurality of hardware components, including a power lock actuator and lock assembly 18, an inside release cable 20, an inside release handle 22, an electric motor 24, and a window regulator 26, are positioned between the outer 14 and inner 16 sheet metal layers when the door 10 is fully assembled.

A trim panel 28 is secured to and extends over the inner sheet metal layer 16 to provide an aesthetically pleasing appearance to a motor vehicle occupant. The trim panel 28 is generally formed by a molding process, as is commonly known to one of ordinary skill in the art. Specific reference is made to U.S. Pat. Nos. 5,387,390; 5,397,409; 5,571,355; 5,885,662; 6,013,210; and 6,017,617. Trim panel 28 is contoured in the lower region to present a map pocket region. At the upper edge of this region, a map pocket opening 29 is provided. The opening 29 can be formed during the molding process or cut or trimmed after molding.

A secondary trim component, generally indicated at 30, of the trim panel 28 is formed separately therefrom. In a preferred embodiment, the secondary trim component 30 is a map pocket component 32. In this case, the map pocket component 32 is formed as a relatively rigid piece separate from the trim panel 28. After complete assembly of the door 10, the map pocket component 32 is accessible to a motor vehicle occupant for storage of items.

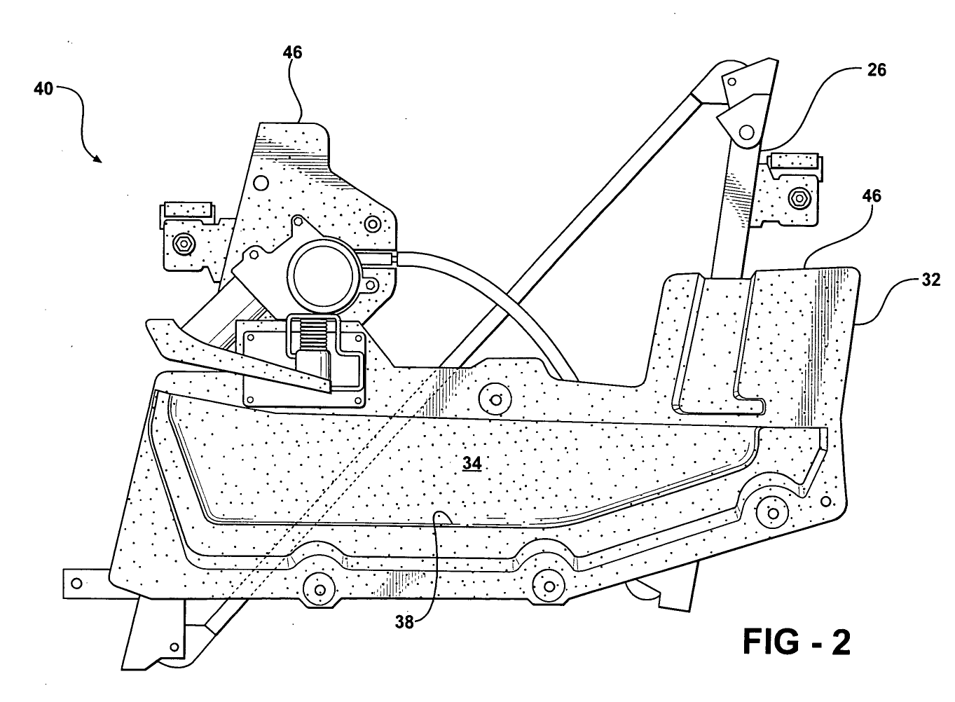

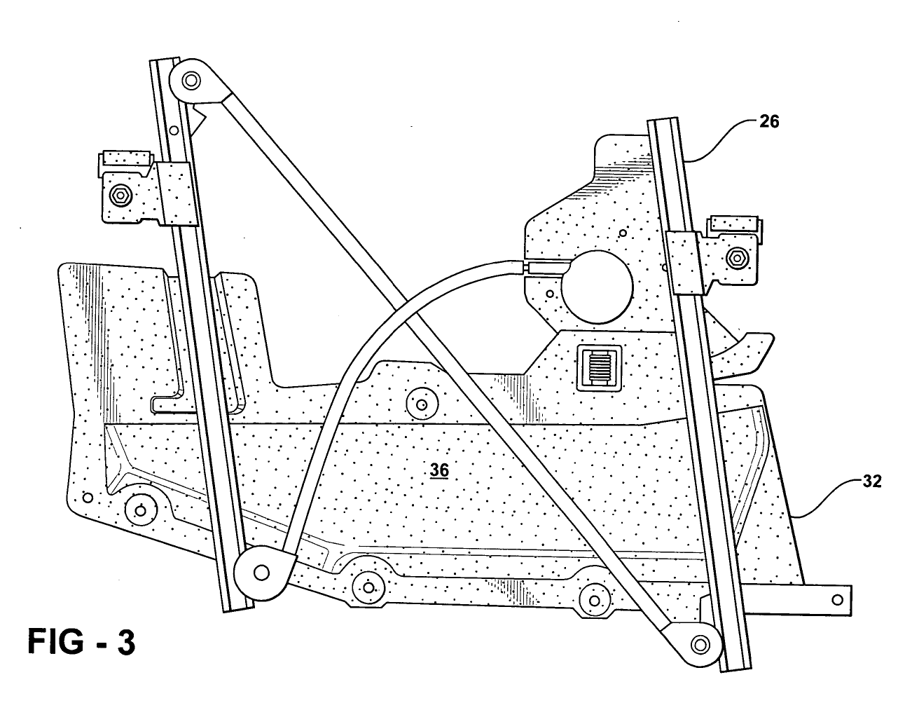

Referring to FIGS. 2 and 3, the map pocket component 32 has an inboard surface 34 facing away from the outer sheet metal layer 14 (FIG. 2), and an outboard surface 36 facing the outer sheet metal layer 14 (FIG. 3). A U-shaped pocket wall or shelf structure 38 is formed along the inboard surface 34. Each of the plurality of hardware components is individually secured to the map pocket component 32 along the outboard surface 36 thereof to form a door module assembly, generally shown at 40. The door module assembly 40 is assembled away from the rest of the motor vehicle door 10. Since the map pocket component 32 is relatively rigid, the map pocket component 32 provides structural integrity for the door module assembly 40. This structural integrity is sufficient for transport from a secondary assembly plant, where the door module assembly 40 is assembled, to an original equipment manufacturer (OEM), where the door module assembly 40 is mounted to the inner sheet metal layer 16.

As the hardware components are secured to the map pocket component 32 to form the door module assembly 40, each of the hardware components is also aligned along the map pocket component 32. Thus, when the door module assembly 40 is mounted to the inner sheet metal layer 16, each of the hardware components is correctly oriented relative to the rest of the door 10.

In addition, after the door module assembly 40 has been assembled (and before mounting of the door module assembly 40 to the inner sheet metal layer 16), each of the hardware components may be individually tested for operational use. As a result, when the door module assembly 40 is secured to the structural door body 12 by the OEM, operability of the each of the hardware components is ensured.

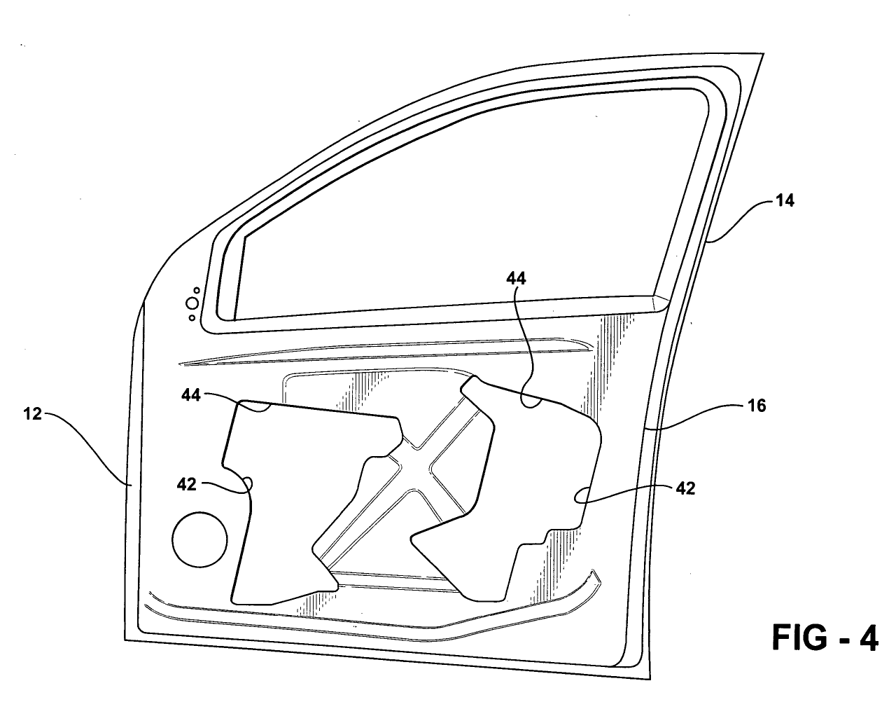

Referring to FIG. 4, access holes 42 are formed in the inner sheet metal layer 16 for receiving the door module assembly 40. Any existing motor vehicle door may be easily modified for receiving the door module assembly 40 by forming the access holes by conventional means, such as stamping. It can be seen that two access holes 42 are formed, each having an irregular shape. It will be appreciated that both the number of access holes 42 and the shape of the access holes 42 may vary depending upon specific needs.

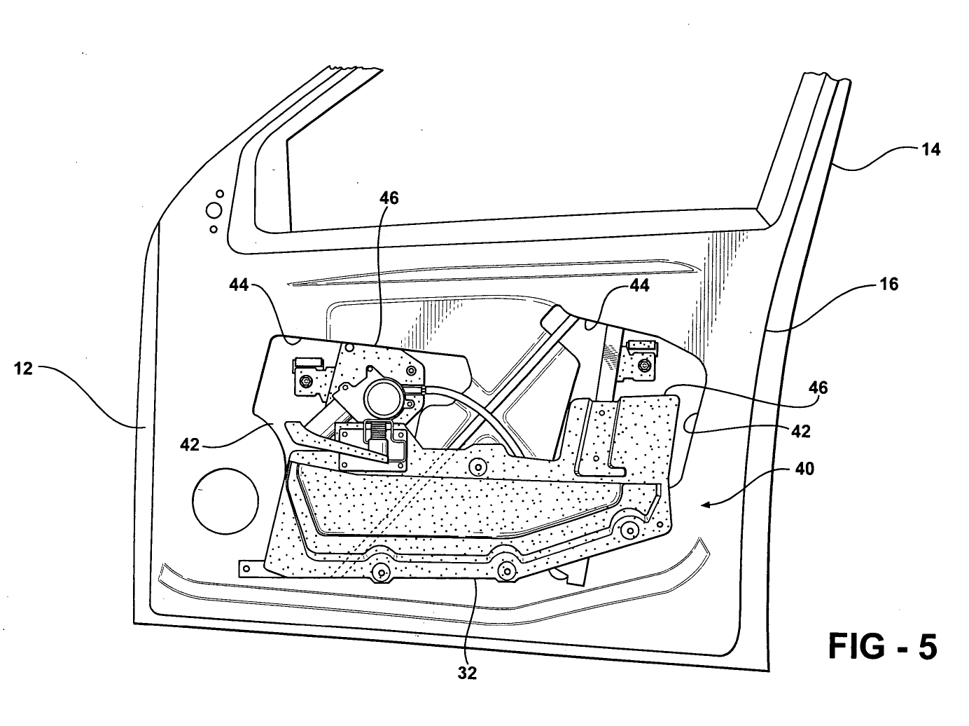

Referring to FIG. 5, the door module assembly 40 is at least partially inserted into the access holes 42 to secure the door module assembly 40 to the inner sheet metal layer 16. The door module assembly 40 may be secured to the inner sheet metal layer 16 by any conventional fasteners, such as bolts, screws, and the like. In the preferred embodiment, after the door module assembly 40 is mounted within the access holes 42, a top portion 44 of each of the access holes 42 above and outside of an upper surface 46 of the map pocket component 32 remains exposed. An individual servicing the hardware components may reach through the top portions 44 of the access holes 42 to gain access to the plurality of hardware components. Consequently, many servicing jobs may be completed without disrupting or dismantling the door construction, resulting in greater integrity of construction following servicing.

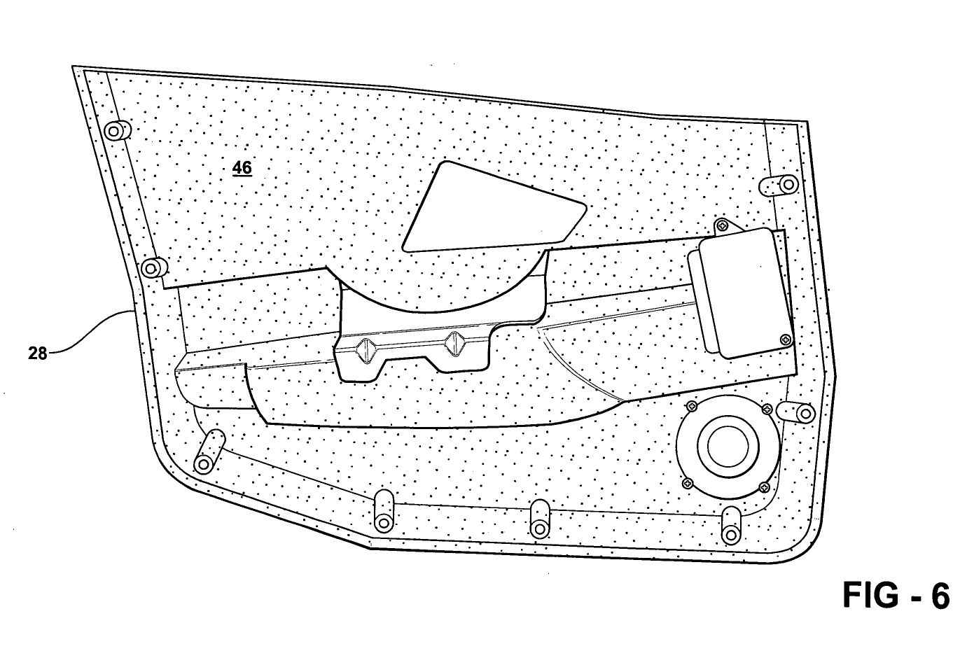

To complete assembly of the door 10, the trim panel 28, shown in FIG. 6, is then mounted over the inner sheet metal layer 16 such that an inner surface 48 of the trim panel 28 faces the inner sheet metal layer 16. The trim panel 28 overlays the door module assembly 40. Map pocket opening 29 aligns with the upper edge of the map pocket wall 38. Together, the trim panel 28 and the map pocket component 32 cooperate to define a map pocket.

A method for assembling the motor vehicle door 10 begins with securing each of the plurality of hardware components, including the inside release handle 18, the inside release cable 20, the power actuator and lock assembly 22, the window regulator 24, and the wiring harness 26, to the secondary trim component 30 to form the door module assembly 40. The secondary trim component 30 is formed separately from the trim panel 28. During attachment of the hardware components to the secondary trim component 30, the hardware components are aligned therealong so that the hardware components are properly oriented after complete assembly of the door 10. The access holes 42 are formed in the inner sheet metal layer 16 by stamping or other conventional methods. The door module assembly 40 is then at least partially inserted into the access holes 42 of the inner sheet metal layer 16 for mounting to the structural door body 12. The trim panel 28 is then secured over the door module assembly 40 to complete assembly of the door 10. If servicing of any of the hardware components is required, the trim panel 28 may be detached from the inner sheet metal layer 16 to expose the door module assembly 40, which is still mounted to the inner sheet metal layer 16. Access to the hardware components may be gained by reaching through the top portions 44 of the access holes 42, thus obviating the need for further disassembly of the door 10.

In another method for assembling the motor vehicle door 10, the method begins with securing each of the plurality of hardware components, including the inside release handle 18, the inside release cable 20, the power actuator and lock assembly 22, the window regulator 24, and the wiring harness 26, to the map pocket component 32. The map pocket component 32 is formed separately from the trim panel 28. During attachment of the hardware components to the map pocket component 32, the hardware components are aligned therealong so that the hardware components are properly oriented after complete assembly of the door 10. The access holes 42 are formed in the inner sheet metal layer 16 by stamping or other conventional methods. The door module assembly 40 is then at least partially inserted into the access holes 42 of the inner sheet metal layer 16 for mounting to the structural door body 12. The trim panel 28 is then secured over the door module assembly 40 to complete assembly of the door 10. If servicing of any of the hardware components is required, the trim panel 28 may be detached from the inner sheet metal layer 16 to expose the door module assembly 40, which is still mounted to the inner sheet metal layer 16. Access to the hardware components may be gained by reaching through the access holes 42, thus obviating the need for further disassembly of the door 10.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A method for assembling a motor vehicle door having a structural door body, a plurality of hardware components, a secondary trim component, and a trim panel, the method comprising the steps of:
providing said trim panel with a map pocket opening;
providing said secondary trim component with a map pocket wall;
affixing the plurality of hardware components to the secondary trim component to form a door module assembly;
installing the door module assembly to the structural door body;
securing the trim panel to the structural door body overlaying the door module assembly, said trim panel cooperating with the secondary trim component to define a map pocket.

2. A method as set forth in claim 1 including the step of forming access holes in the structural door body prior to the step of installing the door module assembly to the structural door body.

3. A method as set forth in claim 2 wherein the installing step includes at least partially inserting the door module assembly into the access holes of the structural door body.

4. A method as set forth in claim 3 wherein the affixing step includes aligning each of the plurality of hardware components along the secondary trim component for orientation relative to the structural door body.

5. A method as set forth in claim 4 including the step of removing the trim panel from the structural door body to expose a portion of the access holes for accessing one of the plurality of hardware components secured to the structural door body.

6. A method for assembling a motor vehicle door having a structural door body, a plurality of hardware components, a map pocket component, and a trim panel, the method comprising the steps of:
affixing the plurality of hardware components to the map pocket component to form a door module assembly;
installing the door module assembly to the structural door body; and
securing the trim panel to the structural door body overlaying the door module assembly.

7. A method as set forth in claim 6 including the step of forming the access holes in the structural door body prior to the step of installing the door module assembly to the structural door body.

8. A method as set forth in claim 7 wherein the installing step includes at least partially inserting the door module assembly into the access holes of the structural door body.

9. A method as set forth in claim 8 wherein the affixing step includes aligning each of the plurality of hardware components along the map pocket component for orientation relative to the structural door body.

10. A method as set forth in claim 9 including the step of removing the trim panel from the structural door body to expose a portion of the access holes for accessing one of the plurality of hardware components secured to the structural door body.

11. A door module comprising
a trim panel having a map pocket opening;
a secondary trim component having a map pocket wall;
a plurality of door hardware components affixed to the secondary trim component;
said trim panel cooperating with the secondary trim component to define a map pocket when the trim panel overlays said secondary trim component.
